(19) United States
(12) Patent Application Publication
(10) Pub. No.: US 2006/0208120 A1
(43) Pub. Date: Sep. 21, 2006

(54) Chipper knife

(76) Inventor: Ronald McGehee, UKIA, CA (US)

Correspondence Address: John R Hlavka;Watts Hoffmann Co, P O Box 99839, Cleveland, OH, 44199-0839, US

(21) Appl. No.: 10/544,658

(22) PCT Filed: Feb. 6, 2004
(86) PCT No.: PCT/CA04/00164

§ 371 Date: Aug. 4, 2005

Related U.S. Application Data
(60) Provisional application No. 60/445,926, filed on Feb. 7, 2003.

(51) Int. Cl. B02C 18/18

(52) U.S. Cl. 241/294

(57) ABSTRACT

A chipper knife (4) for mounting to a rotatable chipper head (7) includes a body having first and second cutting edges (9), a continuous chip deflecting and shaping surface (13) extending between the first and second cutting edges, and a mounting portion to permit the body to be mounted to the rotatable chipper head for rotation in a rotary direction.

### FIELD OF THE INVENTION

This invention relates to the field of chipping heads and in particular to chipper knives of improved design.

### BACKGROUND OF THE INVENTION

As used herein, like characters of reference denote corresponding parts in each illustration. Thus, in wood chipping machinery, a rotating chipper head 7, rotating in direction 16, accepts replaceable knives 4 and is used for shaping a log 1 traveling in direction A to permit downstream processing. Typically multiple chipper heads are positioned together on a common shaft and make up a small portion of larger log processing machinery. The axis of rotation 3 of the chipper head is generally perpendicular to the direction of movement of the log being processed. FIGS. 1 and 2 show a chipper head 7 with chipper knives 4 and associated clamping devices of prior art design. The replaceable chipping knives are typically of a design that provides for two sharp cutting edges 9 per piece as shown in cross section in FIG. 3. The cutting edges are straight lines and positioned parallel to the axis of rotation of the chipper head. The knives are used until one edge is dull then rotated to expose the second sharp edge. After the second edge is used until dull the knife is removed for disposal. In this configuration the knife is held between a top clamp 6 and a counter-knife 5. Both the counter-knife and the top clamp are bolted to the chipper head. The chipper knife together with the counter-knife form an edge and surface respectively that cut, deflect and shape the wood chips (not shown) chipped from the log. The counter-knife is subjected to abrasive wear and must be replaced periodically to maintain acceptable chip quality. This double-edge disposable knife design, with the associated separate counter-knife member, is the most widely used arrangement in saw mills today.

One of the main problems with the knife/counter-knife configuration happens when wood fiber is forced between the two parts during operation. The contaminates in this area can force a gap between the knife and counter-knife causing the knife to move out of position. A deeper cut is produced by the out of position knife which may lead to a defect in the finished lumber. The knife's movement over time may also cause the top knife clamp to bend or break which can lead to machine jam-ups, operational downtime, equipment damage, and safety concerns.

Another problem with the knife/counter-knife configuration is the lack of a smooth transition between the cutting and shaping surfaces. On traditional knife/counter-knife configurations the surface irregularities at the interface between the knife and the counter-knife can lead to undesirable chip characteristics.

Other less common chipper knife configurations of interest include (1) disposable knives that provide only a single cutting edge and (2) reusable knife designs that allow for re-sharpening. Single-edge knives are less economical that a knives with two cutting edges and are therefore not as well received in the marketplace. Designs that require re-sharpening must also provide a means to advance or shim the edge to its proper location on the cutting circle to account for wear. This shimming is typically performed by locating the sharpened knife then pouring a liquid metal (Babbitt) behind it to fix its location. This shimming procedure is time consuming and expensive.

See, for example, the following U.S. Pat. Nos. 4,667,713; 4,771,718; 5,146,963; 5,183,089; 5,333,659; 5,439,039; 5,617,908; and 5,819,826.

### SUMMARY OF THE INVENTION

In summary the chipper knife according to one embodiment of the present invention may be a reversible chipper knife, for mounting to a rotatable chipper head, including a body having first and second cutting edges; a continuous chip deflecting and shaping surface extending between the first and second cutting edges; and a mounting portion to permit the body to be mounted to the rotatable chipper head for rotation in a rotary direction.

The present invention may also be characterized as a chipper head assembly including a chipper head rotatable in a rotary direction and a reversible chipper knife as described above, further including a mounting element, engageable with the mounting portion, securing the body to the chipper head in a first orientation, with the first cutting edge in a cutting position, and in a second orientation, with the second cutting edge in a cutting position; and the chip deflecting and shaping surface being a fully exposed surface facing in the rotary direction when the body is in either of the first or second orientations.

The present invention may also be characterized as a chipper knife, for mounting to a rotatable chipper head, wherein the chipper head is rotatable about a chipper head axis, the knife including a body having a curved cutting edge; and a mounting portion to permit the body to be mounted to a rotatable chipper head for rotation in a rotary direction; and the cutting edge lying at least substantially along a cylindrical surface of revolution so that the cutting edge may be positioned to lie at least substantially along a cylindrical surface of revolution centered on the chipper head axis. The cutting edge, or both the first and second cutting edges for a reversible chipper knife, may be other than parallel to the chipper head axis for example so as to form acute angle therewith.

Each cutting edge may be linear or profiled, for example v-shaped, saw-tooth shaped, or serrated. The v-shaped profiles may have a vertex of the v-shape set back in the v-shape relative to a direction of rotation of the chipping head, or may have a vertex of the v-shape set forwardly in the v-shape relative to a direction of rotation of the chipping head.

Each cutting edge may be a single edge, or two joined edges, or a plurality of joined edges. Each cutting edge may be formed as an array of adjacent serrations wherein the serrations become shallower towards the chip deflecting and shaping surface.

The chip deflecting and shaping surface may extend continuously from, for example so as to blend seamlessly with, the forwardly disposed cutting edge of the knife to form a concavity of substantially circular cross section orthogonal relative to the chipping head axis of rotation. The chip deflecting and shaping surface may be planar immediately adjacent each of its ends, that is adjacent its radially innermost and outermost ends relative to the chipping head axis of rotation.

### BRIEF DESCRIPTION OF THE DRAWINGS

FIG. 1 is, in side elevation view, a prior art chipping head having prior art chipping knives mounted thereon.

FIG. 2 is, in side elevation view, the prior art chipping head and knife arrangement of FIG. 1 illustrating the cutting path or trajectory of the knife.

FIG. 3 is, in cross section view through the prior art chipper knife and clamping mechanism of the prior art chipping head of FIG. 1.

FIG. 4 is, in side elevation cross sectional view, one embodiment of the chipper knife and mounting clamps according to the present invention mounted on a chipping head.

FIG. 5 is, in perspective view, the chipper knife and mounting clamps of FIG. 4.

FIG. 6 is, in perspective view, the chipper knife and mounting clamps of FIG. 5 illustrating the body of revolution about the chipping head axis of rotation formed by the cutting path of the chipper knife.

FIG. 7 is the view of FIG. 6 showing the entire body of revolution.

FIG. 8a is, in side elevation cross sectional view, a chipper knife and mounting clamps according to one embodiment of the present invention.

FIG. 8b is, in side elevation cross sectional view, a further embodiment of the chipper knife and mounting clamps according to the present invention.

FIG. 8c is, in side elevation cross sectional view, a further embodiment of the chipper knife and mounting clamps according to the present invention.

FIG. 8d is, in side elevation cross sectional view, yet a further embodiment of the chipper knife and mounting clamps according to the present invention.

FIG. 9 is, in side elevation cross sectional view, yet a further embodiment of the chipper knife and mounting clamps according to the present invention.

FIG. 10 is, in side elevation cross sectional view, yet a further embodiment of the chipper knife and mounting clamp, mounted on to a chipping head according to the present invention.

FIG. 11 is, in perspective view, yet a further embodiment of an improved chipper knife according to the present invention.

FIG. 12 is, yet a further embodiment of an improved chipper knife according to a further embodiment of the present invention.

FIG. 13 is, in perspective view, yet a further embodiment of the improved chipper knife according to the present invention.

FIG. 14a is, in perspective view, an improved chipper knife according to one embodiment of the present invention illustrating a linear cutting edge set back from parallel to an axis of rotation of the chipping head so as to be non-orthogonal to the cutting path of the knife.

FIG. 14b is, in side elevation cross sectional view partially cut away, one embodiment of the chipper head and mounting clamps according to the present invention showing the cutting knife angled set backs relative to parallel with an axis of rotation of the chipping head.

FIG. 14c is, in side elevation view, a chipping head according to one embodiment of the present invention showing the chipping head in cutting engagement with a log.

FIG. 14d is, in plan view, an improved chipper knife according to one embodiment of FIG. 14b illustrating a linear cutting edge having an angled set back from parallel with an axis of rotation of the chipping head.

FIG. 15 is, in perspective view, yet a further embodiment of an improved chipper knife according to the present invention.

FIG. 16a is, in perspective view, yet a further embodiment of an improved chipper knife according to the present invention as it would be mounted in a chipping head so as to show its orientation relative to an axis of rotation of the chipping head and its annular cutting path.

FIG. 16b is, in plan view, the improved cutting knife of FIG. 16a.

FIG. 17 is, in perspective view, yet a further embodiment of a chipper knife and mounting clamps according to the present invention.

FIG. 18 is, in side elevation cross sectional view, yet a further embodiment of an improved chipper knife and mounting clamps according to the present invention.

FIG. 19 is, in side elevation cross sectional view, yet a further embodiment of a chipper knife and mounting clamps according to the present invention.

FIG. 20 is, in side elevation cross sectional view, yet a further embodiment of an improved chipper knife according to the present invention.

FIG. 21 is, in side elevation cross sectional view, yet a further embodiment of an improved chipper knife according to the present invention.

FIG. 22 is, in side elevation cross sectional view, yet a further embodiment of an improved chipper knife according to the present invention.

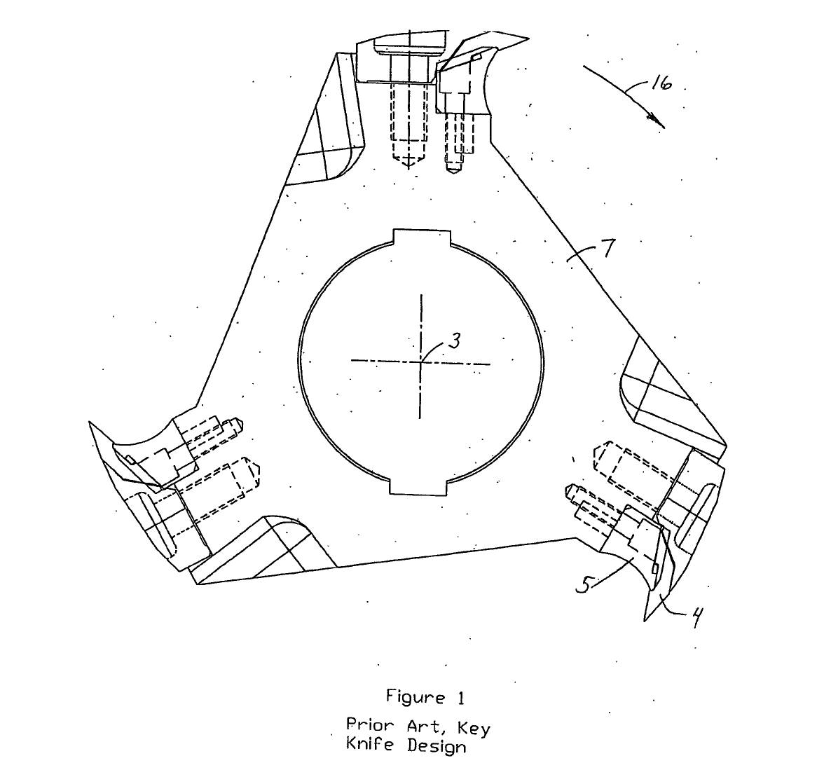

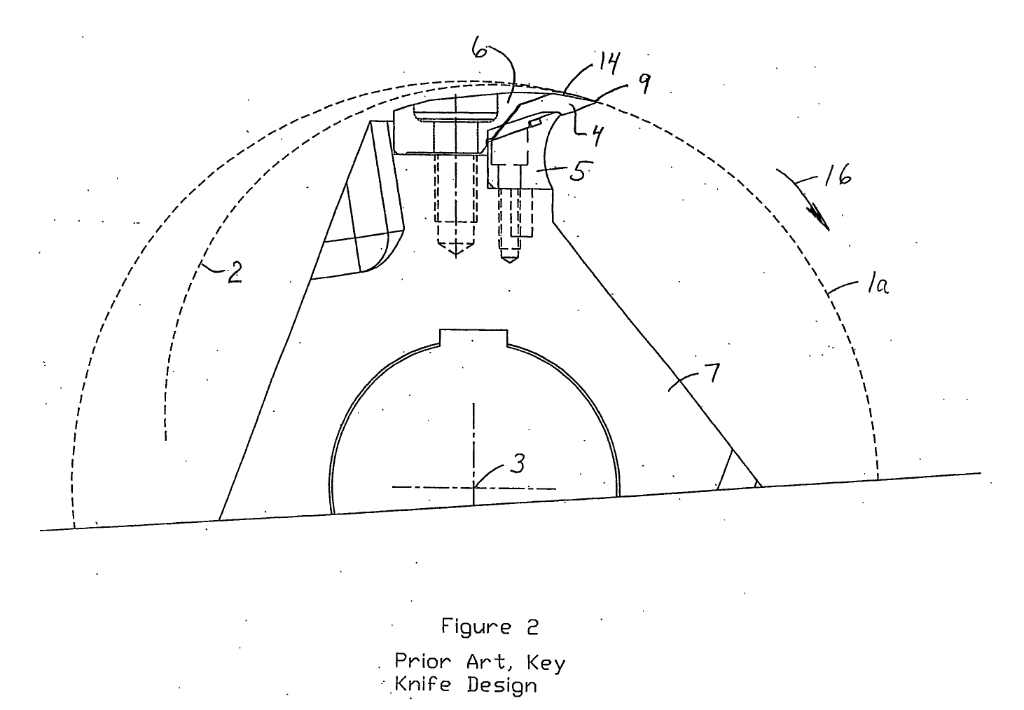

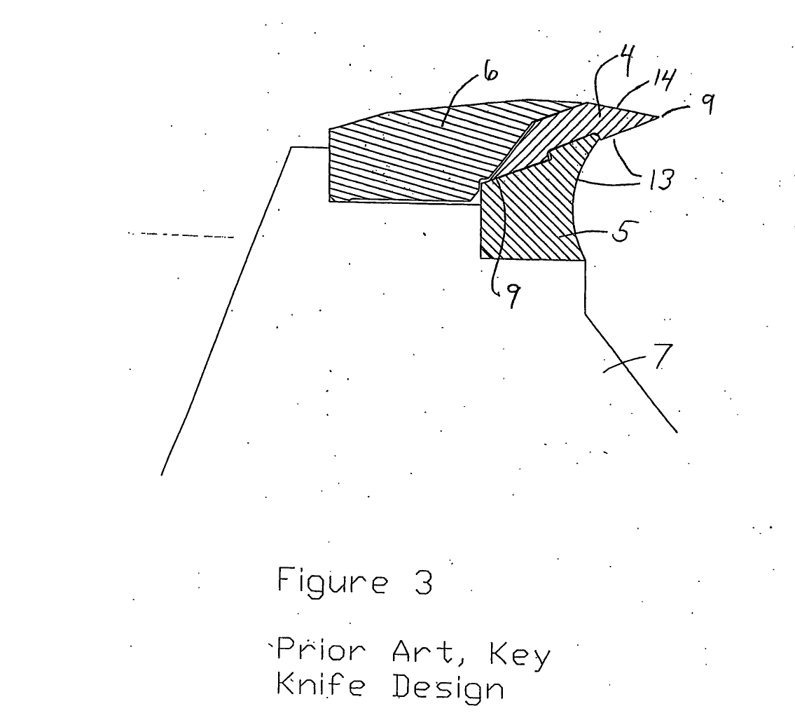

### DETAILED DESCRIPTION OF EMBODIMENTS OF THE INVENTION

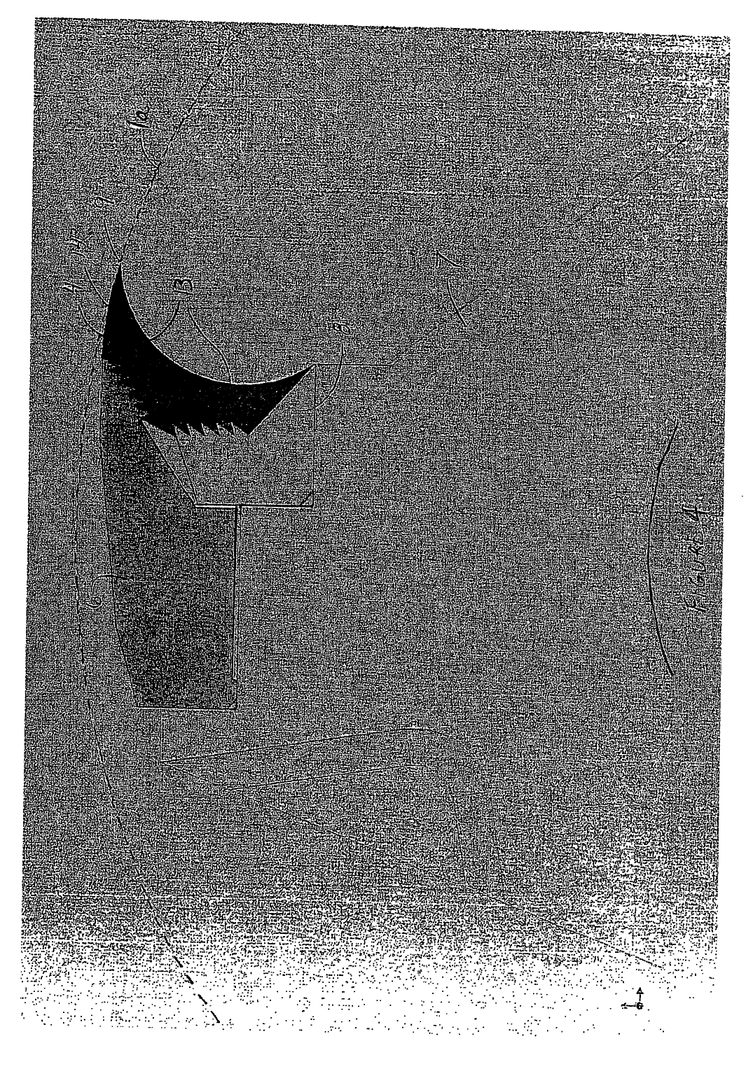

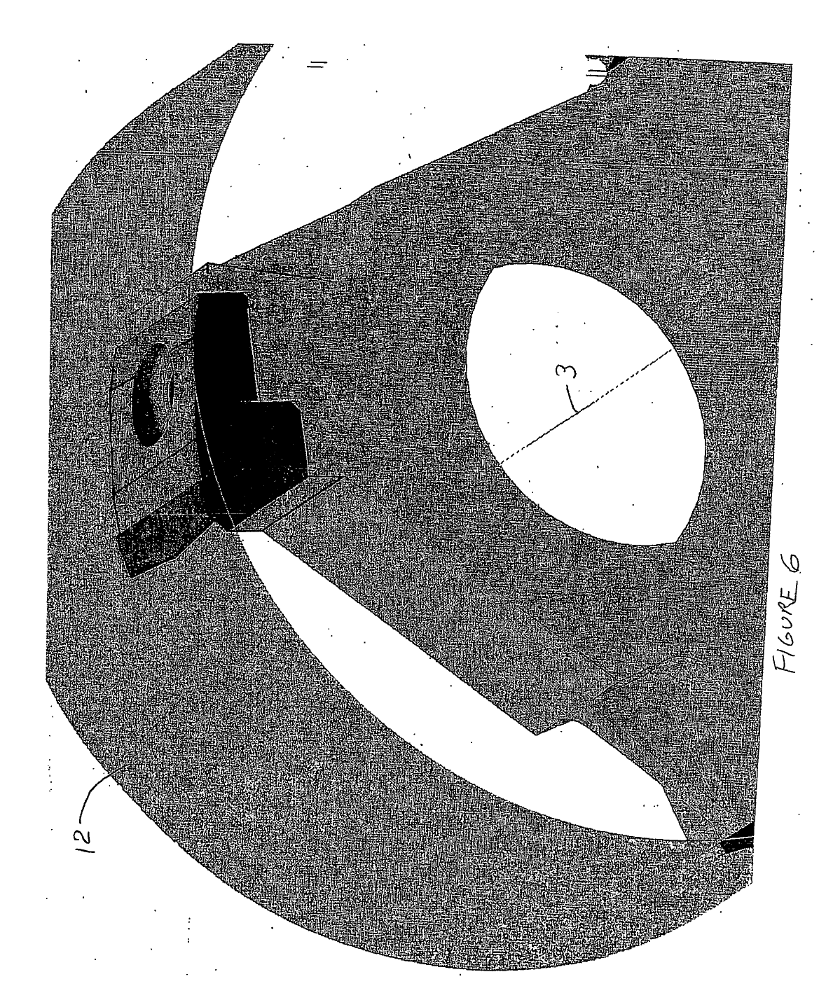

In one preferred embodiment, a double-edged reversible knife 4 with a fully exposed chip deflecting and shaping surface 13 between the two cutting edges 9. The chipper knife and counter-knife in prior art configurations are replaced in the new invention by a single one-piece knife 4 that cuts, deflects and shapes the wood chips. The one-piece knife 4 is held in position by interlocking top and bottom clamps 6 and 8 respectively that are attached to the chipper head 7. The cutting edge is, in this embodiment, defined as other than parallel to the chipper head axis 3 and lying at least substantially along a cylindrical surface of revolution 12 centered on the chipper head axis 3 as seen in FIGS. 4 through 7. In this preferred embodiment, not intended to be limiting, reversible knife 4 has two v-shaped cutting edges 9. Fully exposed chip deflecting and shaping surface 13 extends between these edges. The cutting edge falls along cylindrical surface of revolution 12 centered on the chipper head axis.

Using the one-piece knife according to the present invention eliminates the problems associated with the separate knife/counter-knife configuration. Without the existence of an interface line between the knife and counter-life fiber is not forced under the knife. The knife stays in position and the top clamp is not likely to get bent. The knife retains the economical double-edge features found in many conventional knife configurations. The counter knife, a wear item, is eliminated providing cost savings to saw mills.

A cutting edge 9 that is other than parallel to the chipper head axis 3 and defined as lying at least substantially along cylindrical surface of revolution 12 centered on the chipper head axis produces superior surface finishes than cutting edges not oriented as such. Providing profiled shapes or serrations on the cutting edge 9 of the knife improve cut quality and help reduce fiber tear-out around knots by slicing through the wood rather than chopping on the line of contact with the wood. By using a one-piece knife the profiled shapes or serrations on the cutting edges may be blended seamlessly from the cutting edge into the chip deflecting and shaping surface.

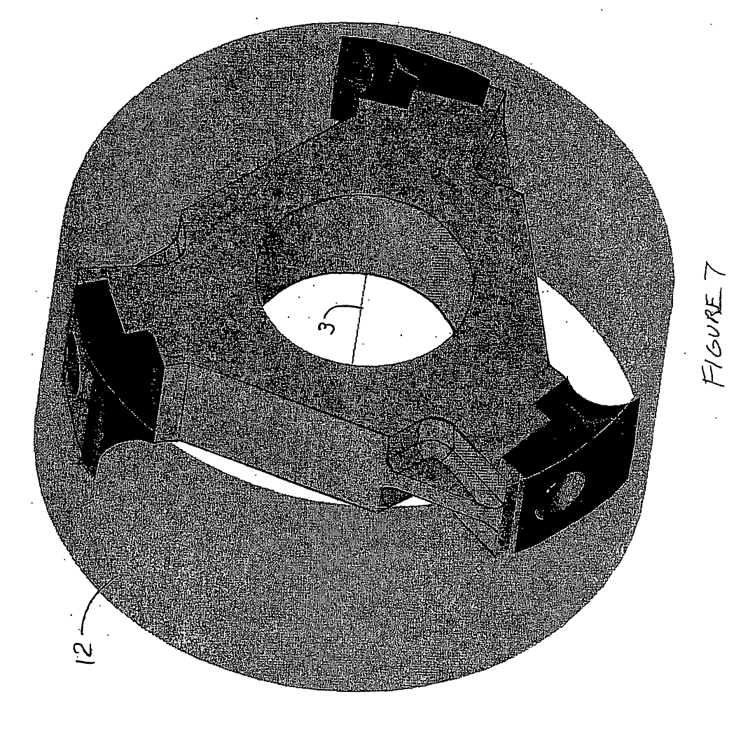

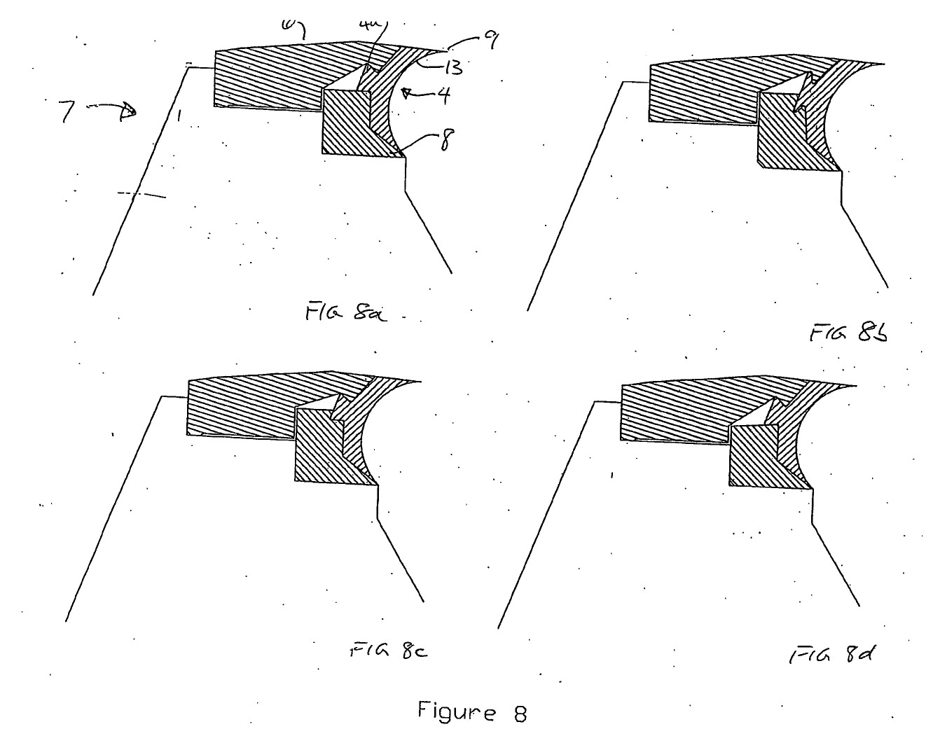

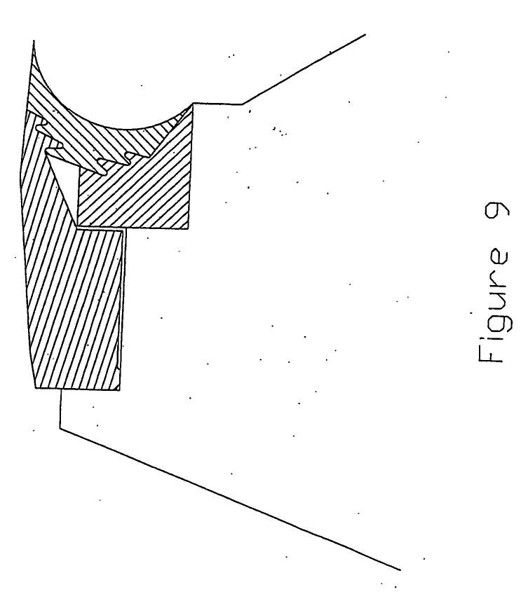

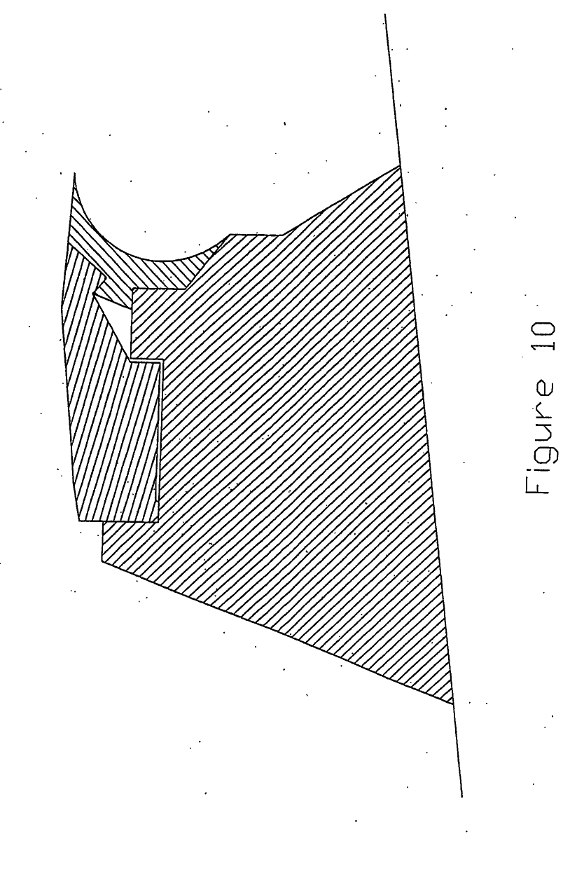

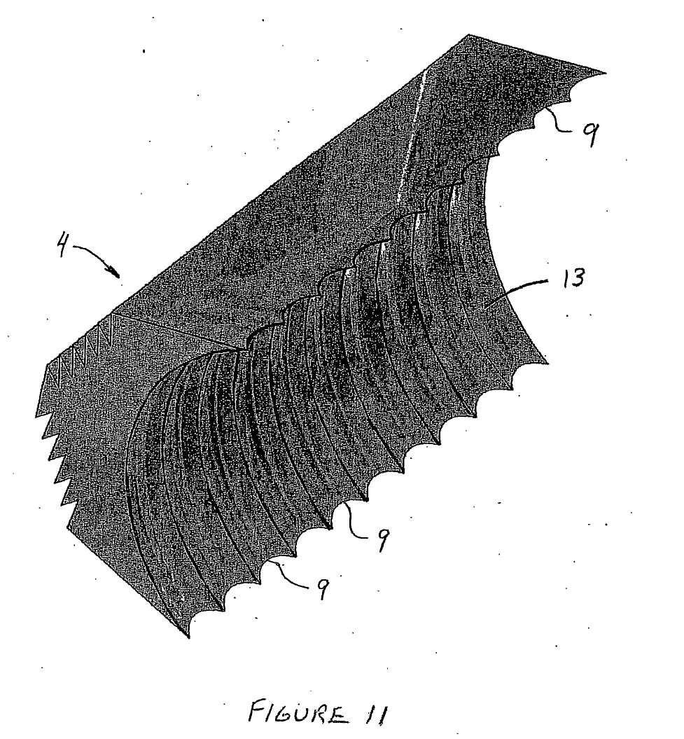

Various clamping embodiments are illustrated in FIGS. 8, 9 and 10, showing different ways of clamping knife 4 in position relative to chipper head 7. In particular FIGS. 8a-8d shows four alternative embodiments with variations of a dovetail clamping arrangement clamping a bass 4a on the back of knife 4 between top clamp 6 and lower clamp 8. FIG. 9 shows an alternative embodiment with a double tooth boss clamped between the top and bottom clamps. The exact design of the clamping mechanism will vary depending on several factors including operational conditions and knife manufacturing requirements as would be known to one skilled in the art. FIG. 10 shows an alternative embodiment wherein the bottom clamp is formed as a part of the chipper head.

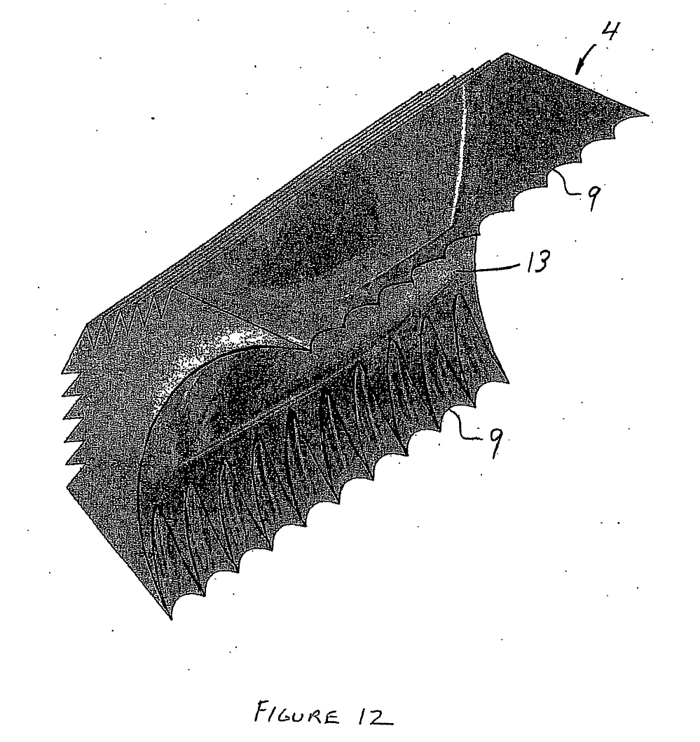

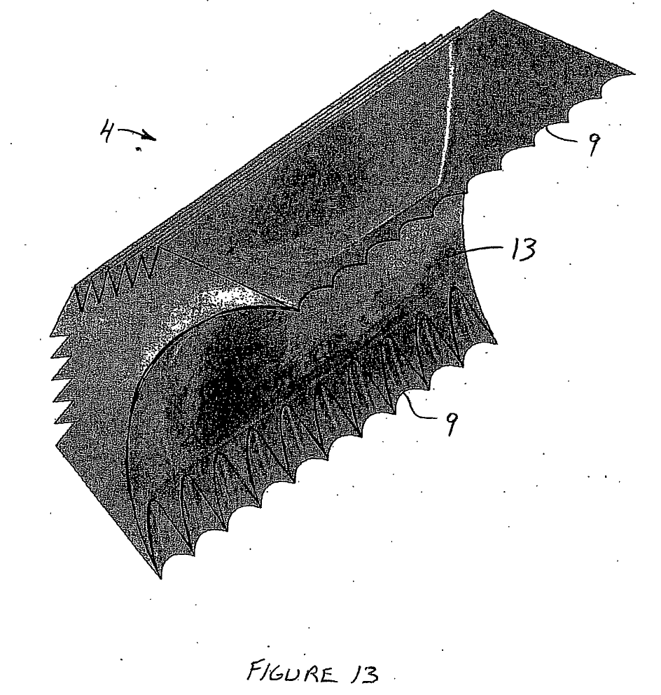

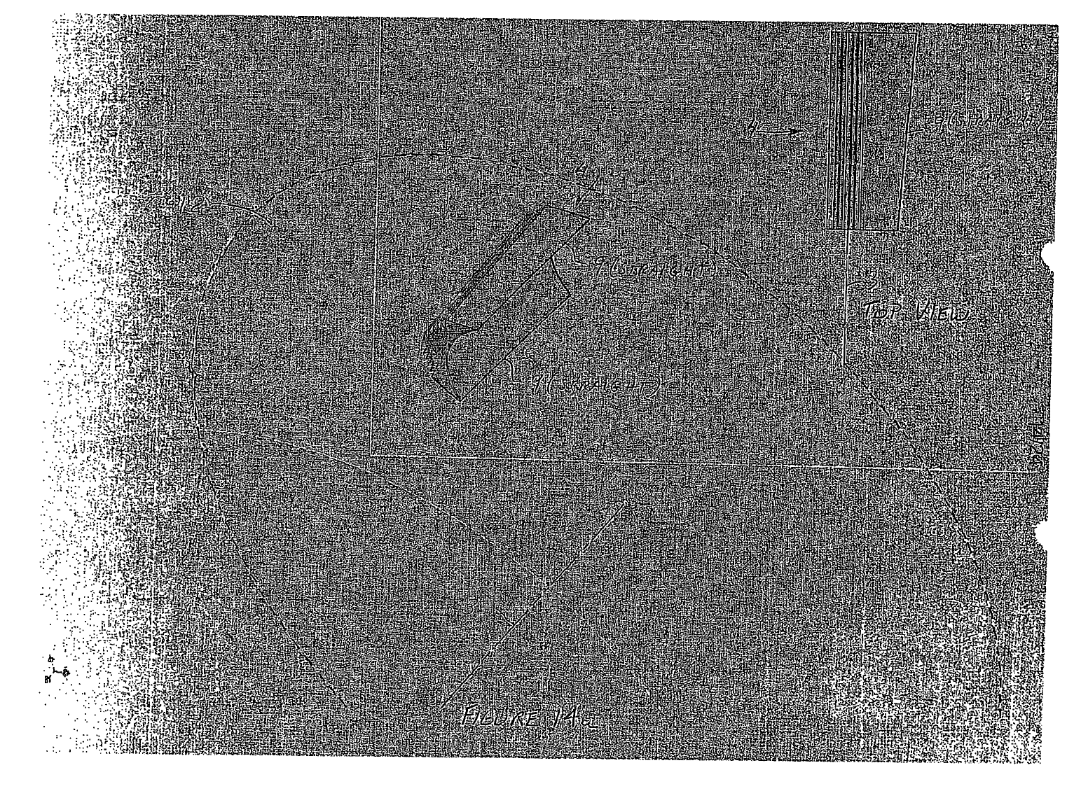

Various cutting edge and shaping surface embodiments are illustrated in FIGS. 11 through 17 which show knives having cutting edges defined as other than parallel to the chipper head axis and lying at least substantially along a cylindrical surface of revolution centered on the chipper head axis. The profiled cutting edge is used to improve chip quality and/or prevent fiber tear-out around knots. The cutting edge may follow a variety of profiles such as diagonal serrations, sinusoidal curves or straight lines. The cutting edge may contain a single edge, two joined edges, or a multitude of joined edges. The knives may or may not be of a reversible design. In particular, FIG. 11 shows an alternative embodiment where two serrated cutting edges blend into the deflecting and shaping portion of the knife. FIGS. 12 and 13 show alternative embodiments where the serrated features on the cutting edges become shallower towards the deflecting and shaping portion of the knife.

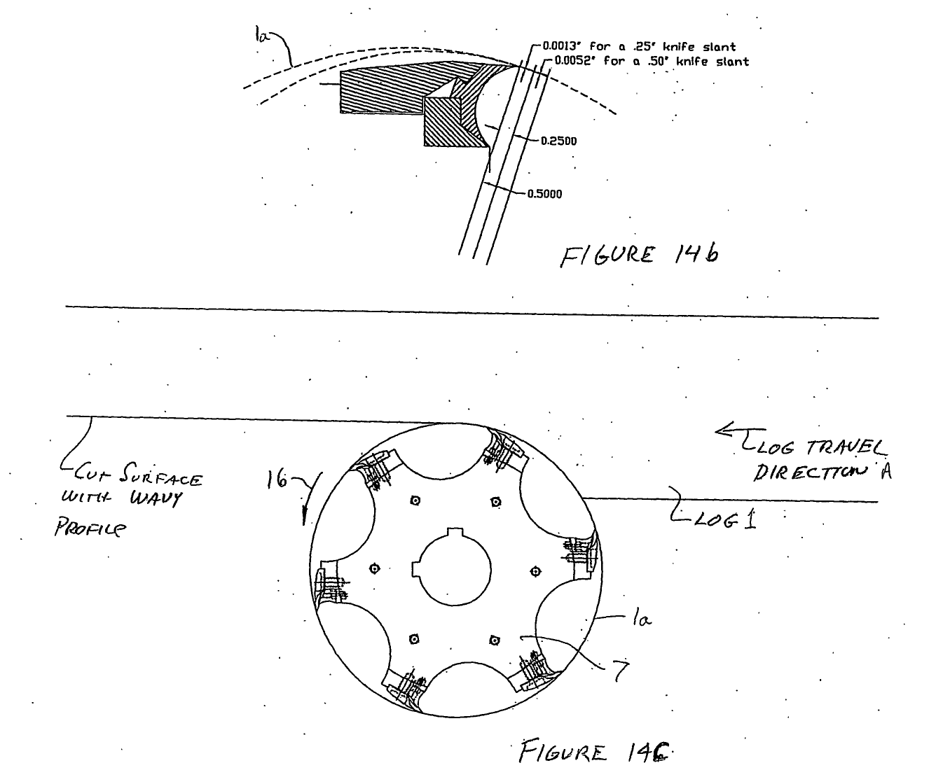

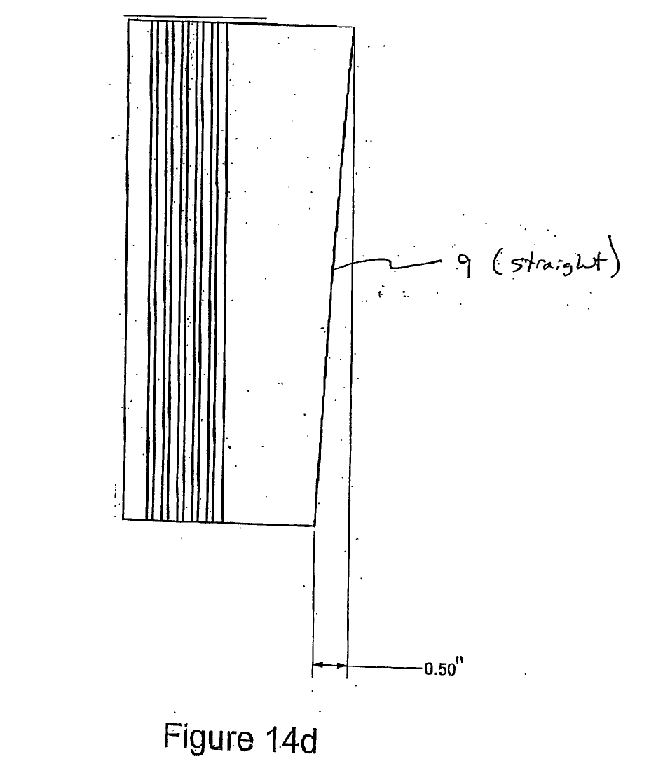

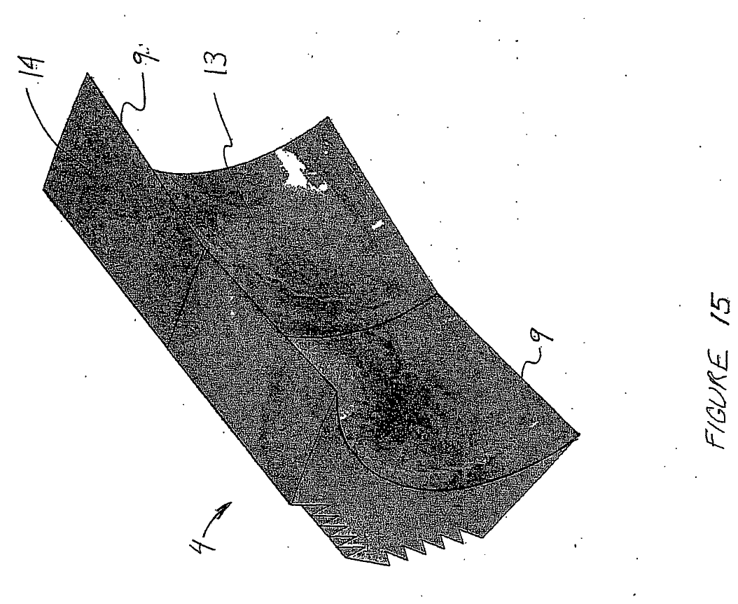

FIG. 14a shows an alternative embodiment where the cutting edge is defined as a straight line not parallel to the chipper head axis, and lying at least substantially along a cylindrical surface of revolution centered on the chipper head axis. A straight line will not lay precisely on the cylindrical surface when angled out of parallel with the chipper head axis. This will cause the knife to cut slightly shallower in its center. Acceptable cutting results will only be achieved if the cutting edge lays substantially on the cylindrical surface of revolution centered on the chipper head axis. If the knife is angled excessively the cutting edge will fall too far off of the cylinder and an unacceptable cut will result.

FIG. 14b shows how this straight cutting edge falls away from the cylindrical surface of revolution centered on the chipper head axis as it is angled. In the example shown the knife's straight cutting edge, typically about 2 inches to 4 inches long, is angled a distance of up to ½″ out of parallel with the chipper head on a 12″ diameter cutting circle while holding the ends of the cutting edge on this cylinder. FIG. 14d shows a top view of this angled straight edged knife. The resulting surface defect caused by this scenario is approximately 0.005″ in elevation above the nominal face of the cut surface. In this example, a surface defect of this size would normally be considered acceptable when compared to the normal wavy pattern left by the chipper knives, typically in a range from 0.010″ to 0.015″.

What is considered an acceptable added surface defect from cutting edges that do not exactly fall on the cylindrical surface of revolution centered on the chipper head axis can vary depending on saw mill specifications, species of wood being cut, and on operational conditions.

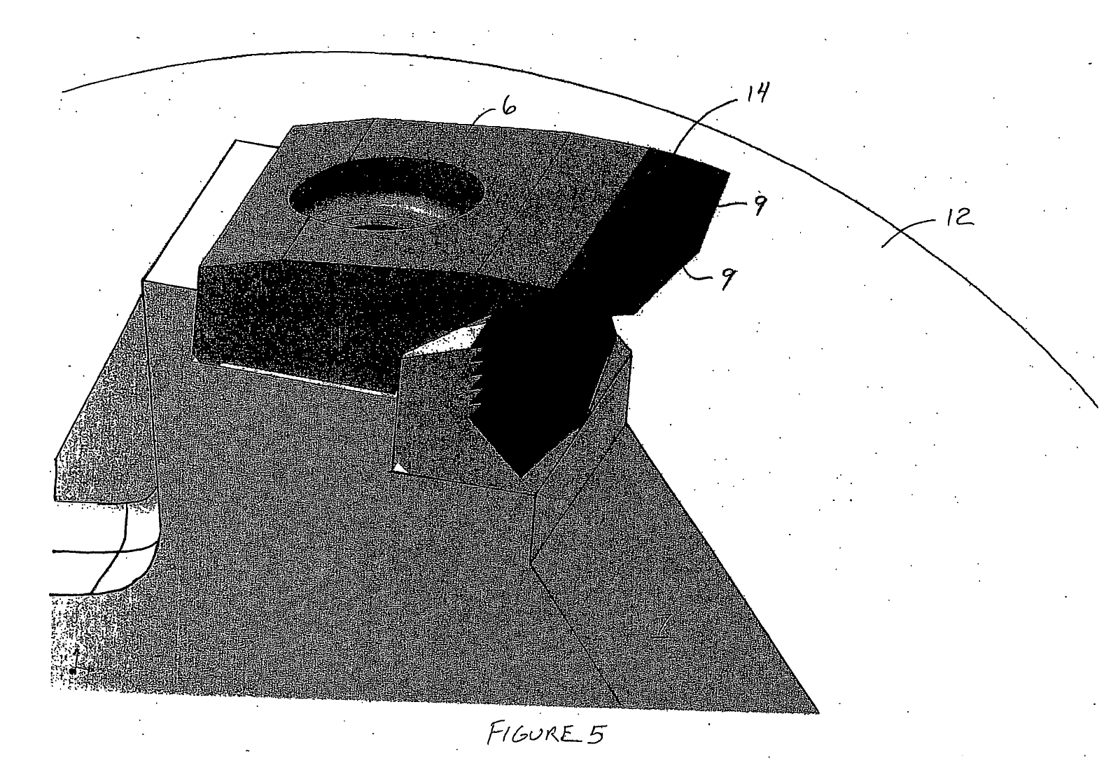

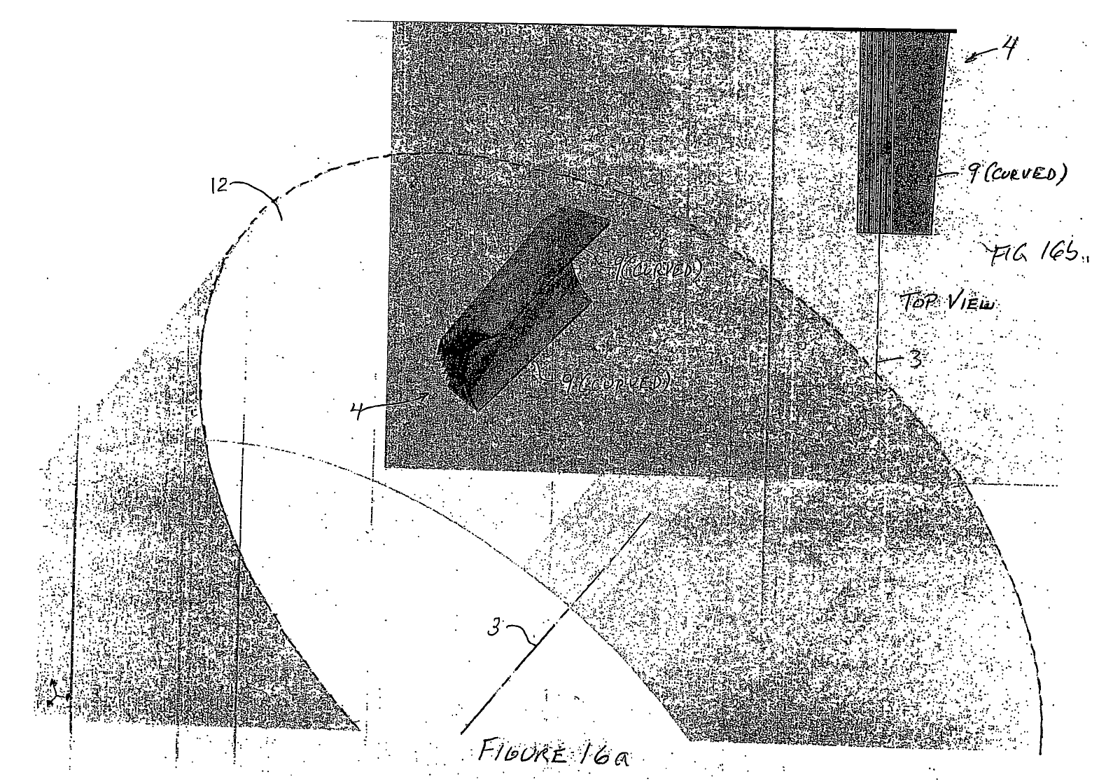

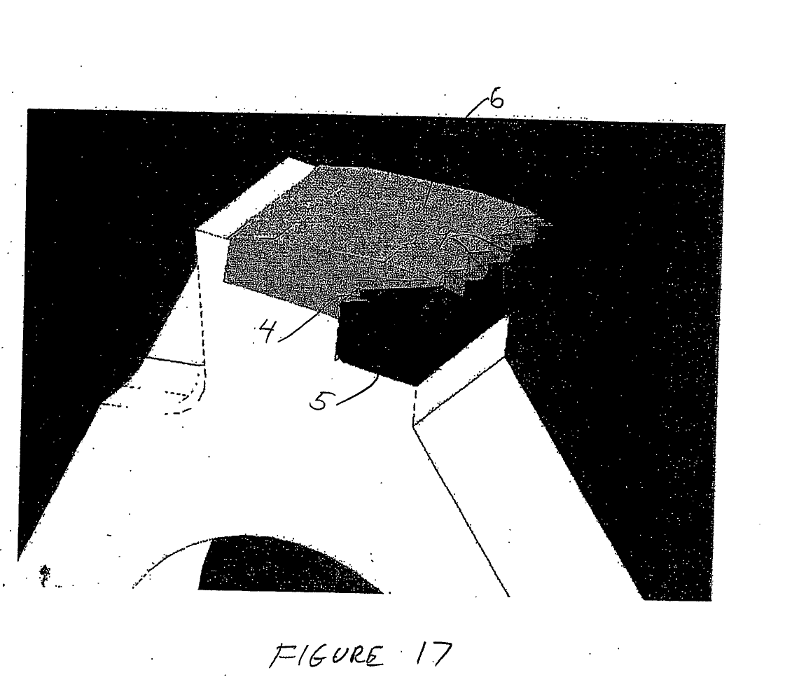

FIG. 15 shows an alternative embodiment where the cutting edge has an inverse shape from the preferred embodiment as shown in FIG. 5. FIG. 16 shows an alternative embodiment where the cutting edge is a single curved cutting edge. FIG. 17 shows an alternative embodiment where the knife is not a double-edged reversible knife with a fully exposed chip deflecting and shaping surface between the two cutting edges. Rather, the knife is used with a counter-knife. The saw-toothed-shaped cutting edge does, however, generally follow a cylindrical surface of revolution.

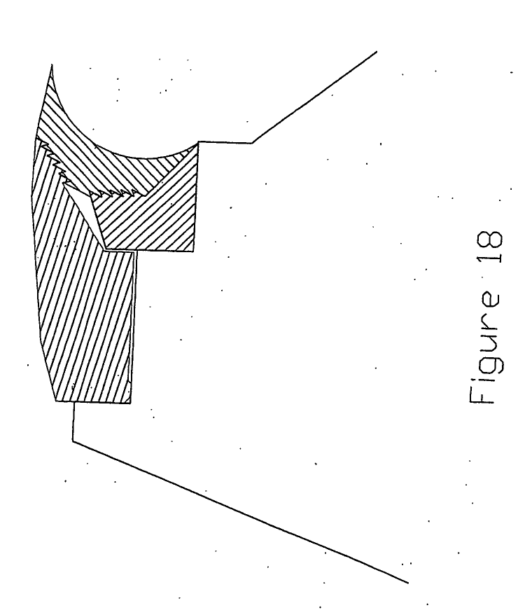

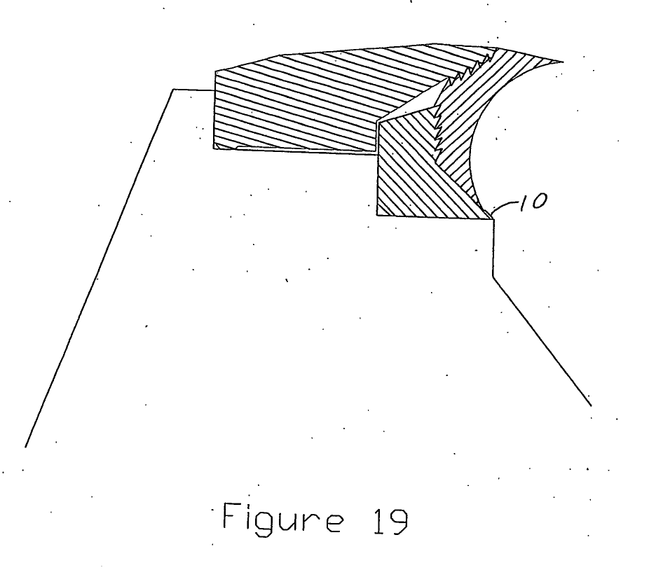

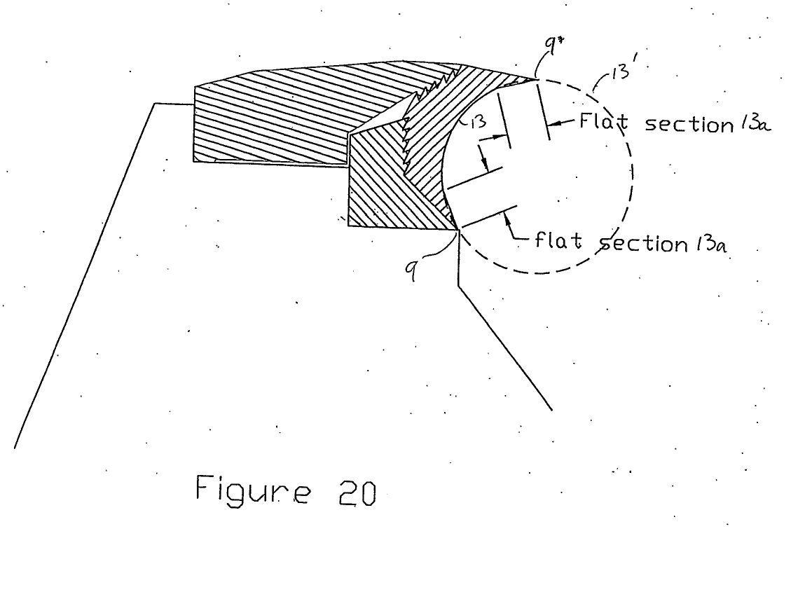

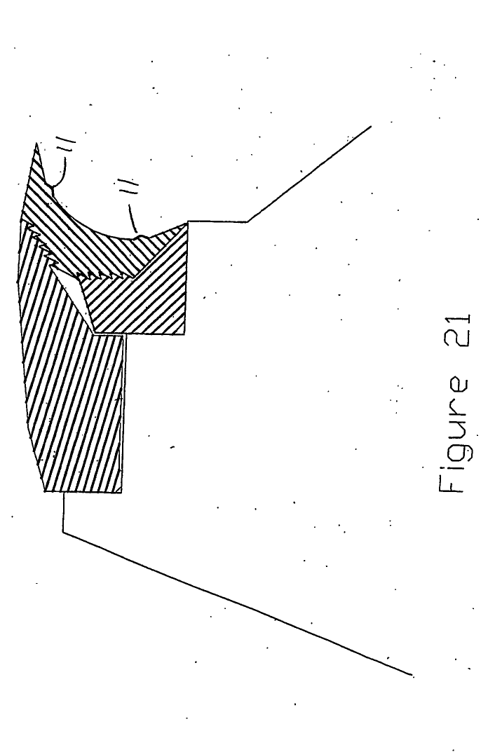

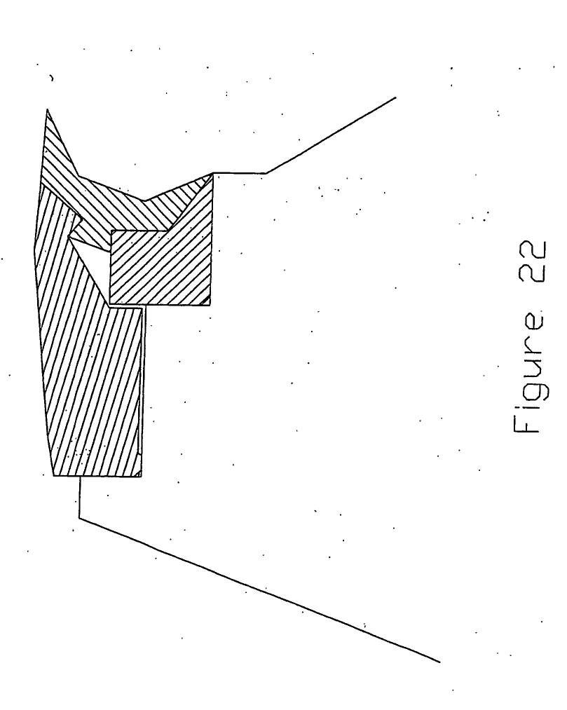

FIGS. 18 through 22 show knives with straight line cutting edges parallel to the chipper head axis of rotation. All variations below are of the double-edged reversible knife design. All variations below contain a fully exposed chip deflecting and shaping surface between the two cutting edges. In particular, FIG. 18 shows an alternative embodiment with a curved chip deflecting and shaping surface. FIG. 19 shows an alternative embodiment where the unused cutting edge on the knife is protected by a raised portion of the lower clamp. FIG. 20 shows an alternative embodiment where flat sections 13a at the knife edges 9 lead into the curved deflecting and shaping surface 13 which otherwise follows the circular cross section profile 13′. FIG. 21 shows an alternative embodiment where raised features are present at the base of the initial cutting area for the purpose of producing uniformly shaped chips. FIG. 22 shows an alternative embodiment where the knife shape is made mostly of simple intersecting planes for the purpose of reducing manufacturing costs.

### DESCRIPTION OF COMPONENTS

1 Log
1a Cutting circle
2 Feed curve
3 Chipper head axis
4 Chipper knife
5 Counter-knife
6 Top clamp
7 Chipper head
8 Lower clamp
9 Cutting edge
10 Edge protection feature
11 Chip breaker feature
12 Cylindrical surface of revolution centered on the chipper head axis
13 Chip deflecting and shaping surface
14 Knife relief surface
15 Cutting circle radius
16 Direction of rotation

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A reversible chipper knife, for mounting to a rotatable chipper head, comprising:
a body comprising:
first and second cutting edges;
a continuous chip deflecting and shaping surface extending between the first and second cutting edges; and
a mounting portion to permit the body to be mounted to a rotatable chipper head for rotation in a rotary direction.

2. A chipper head assembly comprising:
a chipper head rotatable in a rotary direction;
a reversible chipper knife comprising:
a body comprising;
first and second cutting edges;
a continuous chip deflecting and shaping surface extending between the first and second cutting edges; and
a mounting portion;
a mounting element, engageable with the mounting portion, securing the body to the chipper head in a first orientation, with the first cutting edge in a cutting position, and in a second orientation, with the second cutting edge in a cutting position; and
the chip deflecting and shaping surface being a fully exposed surface facing in the rotary direction when the body is in either the first or second orientations.

3. A chipper knife, for mounting to a rotatable chipper head, said chipper head rotatable about a chipper head axis, comprising:
a body comprising:
a curved cutting edge; and
a mounting portion to permit the body to be mounted to a rotatable chipper head for rotation in a rotary direction; and
the cutting edge lying at least substantially along a cylindrical surface of revolution so that said cutting edge may be positioned to lie at least substantially along a cylindrical surface of revolution centered on the chipper head axis.

4. A chipper head assembly comprising:
a chipper head rotatable in a rotary direction;
a chipper knife comprising:
a body comprising:
a cutting edge; and
a mounting portion;
mounting element, engagable with the mounting portion, securing the body to the chipper head with the cutting edge in a cutting position; and
the cutting edge being other than parallel to the chipper head axis and lying at least substantially along a cylindrical surface of revolution centered on the chipper head axis.

5. A reversible chipper knife, for mounting to a rotatable chipper head, said a chipper head rotatable about a chipper head axis, comprising:
a body comprising:
first and second cutting edges;
a continuous chip deflecting and shaping surface extending between the first and second cutting edges;
a mounting portion to permit the body to be mounted to a rotatable chipper head at either a first orientation, with the first cutting edge in a cutting position, or a second orientation, with the second cutting edge in a cutting position;
the first cutting edge being other than parallel to the chipper head axis and lying at least substantially along a cylindrical surface of revolution centered on the chipper head axis when the body is in the first orientation;
the second cutting edge being other than parallel to the chipper head axis and lying at least substantially along a cylindrical surface of revolution centered on the chipper head axis when the body is in the second orientation.

6. A chipper head assembly comprising:
a chipper head rotatable in a rotary direction;
a reversible chipper knife comprising:
a body comprising:
first and second cutting edges;
a continuous chip deflecting and shaping surface extending between the first and second cutting edges; and
a mounting portion;
a mounting element, engageable with the mounting portion, securing the body to the chipper in a first orientation, with the first cutting surface in a cutting position, and in a second orientation, with the second cutting surface in a cutting position;
the first cutting edge being other than parallel to the chipper head axis and lying at least substantially along a cylindrical surface of revolution centered on the chipper head axis when the body is in the first orientation; and
the second cutting edge being other than parallel to the chipper head axis and lying at least substantially along a cylindrical surface of revolution centered on the chipper head axis when the body is in the second orientation.

7. The device of claim 1 wherein each said cutting edge is v-shaped.

8. The device of claim 1 wherein each said cutting edge is saw-tooth shaped.

9. The device of claim 1 wherein each said cutting edge is serrated.

10. The device of claim 1 wherein each said cutting edge forms an acute angle with a chipper head axis of rotation.

11. The device of claim 1 wherein each said cutting edge is linear and angled from a chipper head axis of rotation.

12. The device of claim 1 wherein each said cutting edge is v-shaped having a vertex of the v-shape set back in the v-shape relative to a direction of rotation of the chipping head.

13. The device of claim 1 wherein each said cutting edge is v-shaped having a vertex of the v-shape set forward in the v-shape relative to a direction of rotation of the chipping head.

14. The device of claim 1 wherein each said cutting edge is a single edge.

15. The device of claim 1 wherein each said cutting edge is two joined edges.

16. The device of claim 1 wherein each said cutting edge is a plurality of joined edges.

17. The device of claim 1 wherein each said cutting edge is an array of adjacent serrations and wherein the serrations become shallower towards chip deflecting and shaping surface.

18. The device of claim 1 wherein chip deflecting and shaping surface extends continuously from each said cutting edge to form a concavity of substantially circular cross section orthogonal relative to a chipping head axis of rotation.

19. The device of claim 1 wherein chip deflecting and shaping surface extends continuously from each said cutting edge to form a concavity of substantially circular cross section orthogonally relative to a chipping head axis of rotation and wherein the chip deflecting and shaping surface is planar immediately adjacent each of its ends, that is adjacent its radially innermost and outermost ends relative to the chipping head axis of rotation.

20. The device of claim 1 wherein chip deflecting and shaping surface extends continuously from, and blends seamlessly with, each said cutting surface.
